(19) United States
(12) Patent Application Publication
(10) Pub. No.: US 2024/0394349 A1
(43) Pub. Date: Nov. 28, 2024

(54) SYSTEM AND METHOD FOR DYNAMICALLY ADJUSTING SCREEN TIME BASED ON USER BEHAVIORAL DATA

(71) Applicant: Yosef Schneid, Pomona, NY (US)

(72) Inventor: Yosef Schneid, Pomona, NY (US)

(21) Appl. No.: 18/673,262

(22) Filed: May 23, 2024

Related U.S. Application Data
(60) Provisional application No. 63/468,333, filed on May 23, 2023.

(51) Int. Cl. G06F 21/31

(52) U.S. Cl. CPC G06F 21/316

(57) ABSTRACT

The present disclosure provides a computer-implemented system for managing screen time based on user activity. The system includes a configuration module for receiving user data and generating a record of the input, an activity tracking module with a reference algorithm and a task verification algorithm, and an execution module with a screen time accumulation bank and an execution algorithm. The configuration module includes an administrative account setup step, an individual account setup step, and a behavior rules setup step. The behavior rules setup step generates manual and automatic input rules based on user-designated tasks and physical activity targets. The execution module monitors the balance of the screen time accumulation bank and controls user engagement with the client device based on the balance and schedule rules.

### CROSS-REFERENCE TO RELATED APPLICATIONS

This application claims priority to U.S. Application No. 63/468,333, titled “Systems and Methods for Dynamically Adjusting Screen Time Limits,” filed May 23, 2023 which is hereby incorporated by reference in its entirety.

### BACKGROUND OF THE DISCLOSURE

### 1) Field of the Present Disclosure

The invention relates to the field of digital device usage management, and more specifically to a computer-implemented system for dynamically adjusting screen time limits based on user activity data.

### 2) Description of Related Art

In the digital age, screen time management has become a topic of increasing interest and concern. Screen time refers to the amount of time a person spends interacting with a digital device, such as a smartphone, tablet, computer, or television. These devices have become integral to many aspects of modern life, including communication, work, education, and entertainment. However, excessive screen time can have negative impacts on physical and mental health, particularly for children and adolescents.

Screen time management systems have been developed to help individuals and families regulate their use of digital devices. These systems typically involve setting limits on the amount of time that can be spent on a device within a given period. For example, a parent might set a limit of two hours per day for their child's use of a tablet. Once the limit is reached, the device may automatically lock or restrict access to non-essential functions.

In addition to time-based limits, some screen time management systems also incorporate activity-based incentives. These incentives are designed to encourage users to engage in non-digital activities, such as physical exercise or household chores, in exchange for additional screen time. For example, a child might earn an extra 30 minutes of screen time for every hour they spend reading a book.

Screen time management systems typically require manual input and oversight from an administrator, such as a parent or teacher. The administrator sets the screen time limits and activity-based incentives and may also be responsible for verifying the completion of incentivized activities. However, this manual oversight can be time-consuming and may not effectively encourage responsible digital time management.

In summary, screen time management is a complex issue that involves balancing the benefits of digital device use with the potential risks of excessive screen time. While existing screen time management systems provide some tools for regulating screen time, there is a continuing demand for more effective and efficient solutions. It is desirable to have a system for dynamically adjusting the screen time limit of an individual user based on their physical activity level and the historical data of their screen time usage.

Further studies on effects of screen times exposure can be found in following articles: (a) Montagni I, et al., Screen time exposure and reporting of headaches in young adults: A cross-sectional study. Cephalalgia, 2016. (b) Vella CA, et al., Associations of leisure screen time with cardiometabolic biomarkers in college-aged adults. J Behav. Med., 2020. (c) Wang X, et al., The associations between screen time-based sedentary behavior and depression: a systematic review and meta-analysis. BMC Public Health, 2019. (d) Meyer J, et al., Changes in Physical Activity and Sedentary Behavior in Response to COVID-19 and Their Associations with Mental Health in 3052 US Adults. Int J Environ Res Public Health, 2020.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure pertains to systems and methods for managing screen time based on behavioral data. More specifically, the disclosure relates to a computer-implemented system that dynamically adjusts screen time limits for an individual user based on their physical activity level and historical data of their screen time usage. The present disclosure relates to helping users set healthy limits on their device usage and providing tools to enforce those limits, thereby promoting better digital well-being.

According to an embodiment of the present disclosure, a computer-implemented system is provided. This system includes a processor, a computer-readable memory, a computer-readable storage device, at least one network interface, at least one input interface, at least one output interface, and program instructions stored on the computer-readable storage device for execution by the processor via the computer-readable memory. The stored program instructions include a configuration module for receiving data from a user via a client device and generating a record of the input on at least one database.

The system also includes an activity tracking module for receiving instructions from the user via the client device. This module includes a reference algorithm and a task verification algorithm. Furthermore, the system includes an execution module for receiving instructions from the user via the client device. This module includes a screen time accumulation bank and an execution algorithm.

According to other embodiments of the present disclosure, the configuration module may further include a schedule rules setup step for defining specific periods during which screen time is permitted or prohibited. The execution module may be further configured to cross-check the current time with the schedule rules before permitting individual user engagement with the client device.

In some embodiments, the behavior rules setup step generates a manual input rule based on user-designated tasks, and the task verification algorithm generates a screen time allotment grant upon verification of task completion. In other embodiments, the behavior rules setup step generates an automatic input rule based on user-designated physical activity targets, and the reference algorithm generates a screen time allotment grant upon meeting or exceeding the physical activity targets.

In further embodiments, the execution module includes a display function for presenting the balance of the screen time accumulation bank to the individual user and the administrative user. The administrative user can manually override the screen time limits set by the behavior rules setup step.

In some embodiments, a sanctioned user list is used to limit the access to the computer-implemented system comprising an at least one client device, processor, a computer-readable memory, a computer-readable storage device, at least one network interface, at least one input interface, at least one output interface, and program instructions stored on the computer-readable storage device for execution by the processor via the computer-readable memory.

According to another embodiment of the present disclosure, a method for regulating screen time of an individual user is provided. The method includes the steps of receiving instructions from a user via a client device to execute a configuration module, an activity tracking module, and an execution module. The behavior rules setup step may generate a manual input rule based on user-designated tasks, and the task verification algorithm may generate a screen time allotment grant upon verification of task completion. The behavior rules setup step may generate an automatic input rule based on user-designated physical activity targets, and the reference algorithm may generate a screen time allotment grant upon meeting or exceeding the physical activity targets. The execution module may include a display function for presenting the balance of the screen time accumulation bank to the individual user and the administrative user. The administrative user can manually override the screen time limits set by the behavior rules setup step.

According to yet another embodiment of the present disclosure, a computer-readable storage medium having data stored therein representing software executable by a computer is provided. The software has instructions to receive instructions from a user via a client device to execute a configuration module, an activity tracking module, and an execution module. The configuration module may include an administrative account setup step, an individual account setup step, and a behavior rules setup step. The activity tracking module may include a reference algorithm and a task verification algorithm. The execution module may include a screen time accumulation bank and an execution algorithm.

Embodiments disclosed herein relate to a computer-implemented system comprising an at least one client device, processor, a computer-readable memory, a computer-readable storage device, at least one network interface, at least one input interface, at least one output interface, and program instructions stored on the computer-readable storage device for execution by the processor via the computer-readable memory, the stored program instructions comprising: a configuration module and a sanctioned user list of allowable IP addresses residing in said program instructions stored on said computer-readable storage device allowing or denying said at least one client device to communicate with an activation module residing in said program instructions stored on said computer-readable storage device based on said at least one client device IP address matching a stored at least one IP address, stored in said computer-readable storage device sanctioned user list of allowable IP addresses and if said activation module allows access then; said configuration module for receiving data from a user via a client device and generating a record of the input on at least one database; an activity tracking module for receiving instructions from the user via the client device and including a reference algorithm and a task verification algorithm; and an execution module for receiving instructions from the user via the client device and including a screen time accumulation bank and an execution algorithm.

Embodiments described herein relate to a computer-implemented system comprising a processor, a computer-readable memory, a computer-readable storage device, at least one network interface, at least one input interface, at least one output interface, and program instructions stored on the computer-readable storage device for execution by at the processor via the computer-readable memory, the stored program instructions comprising receiving, from a user via a client device, instructions to execute a configuration module, wherein the configuration module comprises at least an administrative account setup step, an individual account setup step, and a behavior rules setup step; wherein the configuration module receives data via an input from the user via the client device and the stored program instructions receiving the client device ID or the device IP address from the client device and compares the device ID or the device IP address with the sanctioned user list to ensure that the IP address belong to a verified user device. If the IP address matches a verified user device on the sanctioned user list the and the configuration module generates a record of the input on at least one database, receiving, from the user via the client device, instructions to execute an activity tracking module, wherein the activity tracking module comprises at least a reference algorithm and a task verification algorithm, receiving, from the user via the client device, instructions to execute an execution module, wherein the execution module comprises a screen time accumulation bank and an execution algorithm.

In some embodiments, the behavior rules setup step receives behavior data via an input from a user via a client device, wherein the behavior rules setup step generates a manual input rule if the user designates the behavior data to be manually tracked; wherein the behavior rules setup step generates an automatic input rule if the user designates the behavior data to be automatically tracked. In some embodiments, the reference algorithm compares behavior data received via an input from the user via the client device to an automatic input rule, wherein the reference algorithm generates a screen time allotment grant if the behavior data meets requirements of the automatic input rule and generates a screen time allotment denial if the behavior data does not meet the requirements of the automatic input rule.

In some embodiments, the task verification algorithm compares the behavior data received via an input from the user via the client device to a manual input rule, wherein the task verification algorithm generates a screen time allotment grant if the behavior data meets requirements of the manual input rule and generates a screen time allotment denial if the behavior data does not meet the requirements of the manual input rule.

In some embodiments, the screen time accumulation bank receives and compiles screen time allotment grants from the activity tracking module. In some embodiments, the execution algorithm is configured to monitor a balance of the screen time accumulation bank; wherein the execution algorithm displays to the individual user and the administrative user, via a display, the balance of the screen time accumulation bank; wherein the execution algorithm compares the individual user screen time data received from the individual user via a client device to the screen time accumulation bank, and when the balance of the screen time accumulation bank is positive and nonzero, cross-checks the time with a schedule rules input in the configuration module, then, permits individual user engagement with the client device; wherein the execution algorithm prohibits individual user engagement with the client device if a remaining balance of the screen time accumulation bank is zero.

In some embodiments, the administrative user can, at their discretion, manually allow or disallow individual user screen time regardless of an individual user's behavioral data. In some embodiments, the administrative user can set screen time limits for different categories of applications or for individual applications based on the behavioral data of the individual user.

Embodiments described herein relate to a method for regulating screen time of an individual user, the method comprising the steps of: receiving, from a user via a client device, instructions to execute a configuration module, wherein the configuration module comprises at least an administrative account setup step, an individual account setup step, and a behavior rules setup step; wherein, the configuration module receives data via an input from the user via the client device, and generates a record of the input on at least one database, receiving, from the user via the client device, instructions to execute an activity tracking module, wherein the activity tracking module comprises at least a reference algorithm and a task verification algorithm, receiving, from the user via the client device, instructions to execute an execution module, wherein the execution module comprises a screen time accumulation bank and an execution algorithm.

In some embodiments, the behavior rules setup step wherein the behavior rules setup step receives behavior data via an input from a user via a client device, wherein the behavior rules setup step generates a manual input rule if the user designates the behavior data to be manually tracked; wherein the behavior rules setup step generates an automatic input rule if the user designates the behavior data to be automatically tracked.

In some embodiments, the reference algorithm compares behavior data received via an input from the user via the client device to an automatic input rule, wherein the reference algorithm generates a screen time allotment grant if the behavior data meets requirements of the automatic input rule and generates a screen time allotment denial if the behavior data does not meet the requirements of the automatic input rule.

In some embodiments, the task verification algorithm compares the behavior data received via an input from the user via the client device to a manual input rule, wherein the task verification algorithm generates a screen time allotment grant if the behavior data meets requirements of the manual input rule and generates a screen time allotment denial if the behavior data does not meet the requirements of the manual input rule. In some embodiments, the screen time accumulation bank receives and compiles screen time allotment grants from the activity tracking module.

In some embodiments, the execution algorithm is configured to monitor a balance of the screen time accumulation bank; wherein the execution algorithm displays to the individual user and the administrative user, via a display, the balance of the screen time accumulation bank; wherein the execution algorithm compares the individual user screen time data received from the individual user via a client device to the screen time accumulation bank, and when the balance of the screen time accumulation bank is positive and nonzero, cross-checks the time with a schedule rules input in the configuration module, then, permits individual user engagement with the client device; wherein the execution algorithm prohibits individual user engagement with the client device if a remaining balance of the screen time accumulation bank is zero.

In some embodiments, the administrative user can, at their discretion, manually allow or disallow individual user screen time regardless of an individual user's behavioral data. In some embodiments, the administrative user can set screen time limits for different categories of applications or for individual applications based on the behavioral data of the individual user. In some embodiments, the further includes a predictive algorithm that anticipates an individual user's behavioral data based on their historical behavioral data and sets a screen time limit accordingly.

Embodiments described herein relate to a computer-readable storage medium having data stored therein representing software executable by a computer, the software having instructions to: receive, from a user via a client device, instructions to execute a configuration module, wherein the configuration module comprises at least an administrative account setup step, an individual account setup step, and a behavior rules setup step; wherein, the configuration module receives data via an input from the user via the client device, and generates a record of the input on at least one database, receive, from the user via the client device, instructions to execute an activity tracking module, wherein the activity tracking module comprises at least a reference algorithm and a task verification algorithm, and receive, from the user via the client device, instructions to execute an execution module, wherein the execution module comprises a screen time accumulation bank and an execution algorithm.

Embodiments disclosed herein relate to a computer-implemented system comprising a processor, a computer-readable memory, a computer-readable storage device, at least one network interface, at least one input interface, at least one output interface, and program instructions stored on the computer-readable storage device for execution by the processor via the computer-readable memory, the stored program instructions comprising: a configuration module for receiving data from a user via a client device and generating a record of the input on at least one database; an activity tracking module for receiving instructions from the user via the client device and including a reference algorithm and a task verification algorithm; and an execution module for receiving instructions from the user via the client device and including a screen time accumulation bank and an execution algorithm.

In some embodiments, the configuration module further includes a schedule rules setup step for defining specific periods during which screen time is permitted or prohibited. In some embodiments, the execution module is further configured to cross-check the current time with the schedule rules before permitting individual user engagement with the client device.

In some embodiments, the behavior rules setup step generates a manual input rule based on user-designated tasks, and the task verification algorithm generates a screen time allotment grant upon verification of task completion. In some embodiments, the behavior rules setup step generates an automatic input rule based on user-designated physical activity targets, and the reference algorithm generates a screen time allotment grant upon meeting or exceeding the physical activity targets.

In some embodiments, the execution module further includes a display function for presenting the balance of the screen time accumulation bank to the individual user and the administrative user. In some embodiments, the administrative user can manually override the screen time limits set by the behavior rules setup step.

Embodiments described herein further relate to a method for regulating screen time of an individual user, the method comprising: receiving, from a user via a client device, instructions to execute a configuration module, wherein the configuration module includes at least an administrative account setup step, an individual account setup step, and a behavior rules setup step; receiving, from the user via the client device, instructions to execute an activity tracking module, wherein the activity tracking module includes at least a reference algorithm and a task verification algorithm; receiving, from the user via the client device, instructions to execute an execution module, wherein the execution module includes a screen time accumulation bank and an execution algorithm.

In some embodiments, the behavior rules setup step generates a manual input rule based on user-designated tasks, and the task verification algorithm generates a screen time allotment grant upon verification of task completion.

In some embodiments, the behavior rules setup step generates an automatic input rule based on user-designated physical activity targets, and the reference algorithm generates a screen time allotment grant upon meeting or exceeding the physical activity targets. In some embodiments, the behavior rules setup step matches the sanctioned user list with the user ID present for the user ID designated physical activity targets and allows or declines the automatic input rule based on the matching verification. In some embodiments, the execution module further includes a display function for presenting the balance of the screen time accumulation bank to the individual user and the administrative user. In some embodiments, the administrative user can manually override the screen time limits set by the behavior rules setup step. In some embodiments, the manual input rule includes a task deadline, and the task verification algorithm conditions the screen time allotment grant based on satisfaction of the manual input rule on or before the task deadline.

In some embodiments, the automatic input rule includes a physical activity target of a predetermined number of steps, and the reference algorithm generates the screen time allotment grant upon the user exceeding the predetermined number of steps.

Embodiments described herein further relate to a computer-readable storage medium having data stored therein representing software executable by a computer, the software having instructions to: receive, from a user via a client device, instructions to execute a configuration module, wherein the configuration module includes at least an administrative account setup step, an individual account setup step, and a behavior rules setup step; receive, from the user via the client device, instructions to execute an activity tracking module, wherein the activity tracking module includes at least a reference algorithm and a task verification algorithm; and receive, from the user via the client device, instructions to execute an execution module, wherein the execution module includes a screen time accumulation bank and an execution algorithm.

In some embodiments, the configuration module further includes a schedule rules setup step for defining specific periods during which screen time is permitted or prohibited. In some embodiments, the execution module is further configured to cross-check the current time with the schedule rules before permitting individual user engagement with the client device.

In some embodiments, the behavior rules setup step generates a manual input rule based on user-designated tasks, and the task verification algorithm generates a screen time allotment grant upon verification of task completion. In some embodiments, the behavior rules setup step generates an automatic input rule based on user-designated physical activity targets, and the reference algorithm generates a screen time allotment grant upon meeting or exceeding the physical activity targets. In some embodiments, the execution module further includes a display function for presenting the balance of the screen time accumulation bank to the individual user and the administrative user.

The foregoing general description of the illustrative embodiments and the following detailed description thereof are merely exemplary embodiments of the teachings of this disclosure and are not restrictive.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a block diagram of a distributed computer system to implement one or more embodiments of the present disclosure.

FIG. 2 illustrates a block diagram of an electronic device that can implement one or more embodiments of the present disclosure.

FIG. 3 illustrates a high-level process flow for monitoring and limiting screen time based on activity input.

FIG. 4 shows a configuration module workflow according to an embodiment of the present disclosure.

FIG. 5 shows an activity tracking module workflow according to an embodiment of the present disclosure.

FIG. 6 shows an execution module workflow according to an embodiment of the present disclosure.

FIG. 7 shows a high-level system architecture according to an embodiment of present disclosure.

FIG. 8 shows a high-level system architecture with a central server in communication with a sanctioned user database according to an embodiment of the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various embodiments and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The term “screen time” shall be used herein to describe the act of engaging with a screen on one or more user devices. This shall include any period of time where one or more user devices is unlocked and a user is observing, reading, taking photos, typing, providing input, directing, or otherwise interacting with the screen of the one or more user devices.

The term “behavior data” shall be used herein to describe any input collected that represents conduct or actions taken outside engaging with one or more user devices. This shall include any indication of completed tasks, health information such as real-time heart rate data or distance travelled, geolocation data, and any other relevant data.

The present disclosure pertains to systems and methods for managing screen time based on behavioral data. More specifically, the disclosure relates to a computer-implemented system that dynamically adjusts screen time limits for an individual user based on their physical activity level and historical data of their screen time usage.

The present disclosure relates to helping users set healthy limits on their device usage and providing tools to enforce those limits, thereby promoting better digital well-being. The present disclosure may also be useful to help parents oversee the digital habits of their children, and to further incentivize them to complete household duties, engage in healthy screen-free activities, and develop better focus habits. In addition, the present disclosure may be useful to adults seeking to reform digital habits and/or limit their own screen time.

In some embodiments, the system includes a configuration module that receives data from a user via a client device and generates a record of the input on at least one database. The configuration module may include an administrative account setup step, an individual account setup step, and a behavior rules setup step. In some embodiments, the configuration module further records the device ID or the device IP address associated with the individual account or the administrative account. In some embodiments, the configuration module includes a sanctioned user list comprising allowable device IP address(es) associated with the individual account or the administrative account. In some embodiments, the sanctioned user list includes allowable device IDs associated with the individual account or the administrative account.

In some embodiments, the system also includes an activity tracking module that receives instructions from the user via the client device. This module may include a reference algorithm and a task verification algorithm, which compare the user's behavior data to automatic and manual input rules respectively and generate screen time allotment grants or denials based on whether the behavior data meets the requirements of the input rules. In some embodiments, the activity tracking module matches the user's device ID or IP address with the sanctioned user list in the configuration module before applying the input rules to the behavior data.

In other embodiments, the system includes an execution module that receives instructions from the user via the client device. This module may include a screen time accumulation bank and an execution algorithm. The execution algorithm monitors the balance of the screen time accumulation bank, displays the balance to the individual user and the administrative user, and compares the individual user's screen time data to the screen time accumulation bank. The execution algorithm may permit or prohibit individual user engagement with the client device based on the balance of the screen time accumulation bank and a schedule rules input in the configuration module.

The system and methods disclosed herein may provide a more effective and flexible approach to managing screen time, promoting a balance between digital and non-digital activities, and encouraging healthy habits.

In some embodiments, the computer-implemented system may include various components such as a processor, a computer-readable memory, a computer-readable storage device, at least one network interface, at least one input interface, and at least one output interface. These components may work together to execute program instructions stored on the computer-readable storage device.

In some embodiments, the configuration module of the system may include a schedule rules setup step. This step may allow for the definition of specific periods during which screen time is permitted or prohibited. For instance, the administrative user may set up rules that restrict screen time during school hours or late at night to ensure that the individual user focuses on their studies or gets adequate sleep.

In other embodiments, the execution module of the system may cross-check the current time with the schedule rules before permitting individual user engagement with the client device. This operational variation ensures that the screen time rules set up by the administrative user are adhered to. For example, if the schedule rules prohibit screen time after 9 PM, the execution module may prevent the individual user from accessing their device after this time. This feature may provide an effective way to manage and control screen time based on the individual user's schedule and the administrative user's preferences.

In some embodiments, the configuration module may play a role in receiving data from a user via a client device and generating a record of the input on at least one database. This data may include user-specific information, device details, and behavioral data. The configuration module may be designed to facilitate the setup of the system according to the user's preferences and requirements.

In some embodiments, the configuration module records the device IP address or device ID at the time of individual account creation. The device ID or device IP may be used to create a sanctioned user list, the configuration module allowing or denying the record of an input into the database based on the device ID or device IP address matching that of the sanctioned user list. In some embodiments, the configuration module may further include allow or deny further communication with the activation module or the execution module based on the device ID or the device IP address matching the sanctioned user list.

In some embodiments, the configuration module may include a behavior rules setup step. This step may generate a manual input rule based on tasks designated by the user. For instance, the user may set a rule that grants additional screen time upon completion of specific tasks such as homework, chores, or physical activities. The task verification algorithm, which is part of the activity tracking module, may then generate a screen time allotment grant upon verification of task completion. This functional variation may provide a way for users to earn additional screen time by completing designated tasks, thereby promoting a balance between screen time and other activities.

In other embodiments, the configuration module may include a schedule rules setup step. This step may allow the user to define specific periods during which screen time is permitted or prohibited. For example, the user may set rules that restrict screen time during school hours, work hours, or late at night. This functional variation may provide a way for users to manage and control screen time based on their schedule and preferences. The schedule rules setup step may be particularly useful for parents or guardians who wish to manage the screen time of their children or wards.

In some embodiments, the system may include an activity tracking module. This module may function to receive instructions from the user via a client device. The activity tracking module may include components such as a reference algorithm and a task verification algorithm. These components may play a role in comparing the user's behavior data to automatic and manual input rules, respectively. Based on this comparison, the reference algorithm and the task verification algorithm may generate screen time allotment grants or denials.

In some embodiments, the behavior rules setup step, which is part of the configuration module, may generate an automatic input rule based on physical activity targets designated by the user. For instance, the user may set a rule that grants additional screen time upon achieving a specific number of steps or minutes of physical activity. The reference algorithm, which is part of the activity tracking module, may then generate a screen time allotment grant upon meeting or exceeding these physical activity targets. This functional variation may provide a way for users to earn additional screen time by engaging in physical activities, thereby promoting a balance between screen time and physical activity.

In other embodiments, the execution module of the system may include a display function. This function may present the balance of the screen time accumulation bank to the individual user and the administrative user. For example, the display function may show the current balance of screen time that the individual user has earned through physical activities or task completion. This functional variation may provide users with a clear and real-time understanding of their screen time balance, thereby enabling them to manage their screen time more effectively.

In some embodiments, the behavior rules setup step may generate a manual input rule based on tasks designated by the user. For instance, the user may set a rule that grants additional screen time upon completion of specific tasks such as homework, chores, or physical activities. The task verification algorithm, which is part of the activity tracking module, may then generate a screen time allotment grant upon verification of task completion. This operational variation may provide a way for users to earn additional screen time by completing designated tasks, thereby promoting a balance between screen time and other activities.

In other embodiments, the behavior rules setup step may generate an automatic input rule based on physical activity targets designated by the user. For instance, the user may set a rule that grants additional screen time upon achieving a specific number of steps or minutes of physical activity. The reference algorithm, which is part of the activity tracking module, may then generate a screen time allotment grant upon meeting or exceeding these physical activity targets. This operational variation may provide a way for users to earn additional screen time by engaging in physical activities, thereby promoting a balance between screen time and physical activity.

In some embodiments, the system may include an execution module that receives instructions from the user via a client device. This module may include a screen time accumulation bank and an execution algorithm. The screen time accumulation bank may be a virtual repository where screen time allotments, granted based on the user's behavior data, are stored. The execution algorithm may be responsible for monitoring the balance of the screen time accumulation bank, which represents the total amount of screen time available to the individual user.

In some embodiments, the execution algorithm may monitor the cumulative balance of screen time accumulation bank, which represents the total amount of screen time available to the individual user across multiple devices. In some embodiments, devices included for monitoring the cumulative balance of screen time accumulation bank may be smartphones, laptops, tablets, personal computers, televisions, or other devices including a screen. In some embodiments, the execution module matches the device ID or IP address with sanctioned user list to allow or deny the monitoring of cumulative balance of the screen time accumulation bank by the execution algorithm.

In some embodiments, the execution algorithm may display the balance of the screen time accumulation bank to the individual user and the administrative user. This display may be presented on a user interface of the client device, providing real-time information about the available screen time. This feature may enable the individual user to manage their screen time effectively and the administrative user to monitor the individual user's screen time usage.

In some embodiments, the execution algorithm records the screen time for each device individually by matching the device ID or the device IP address with the screen time on that particular device. In some embodiments, the execution algorithm may display the screen time of each individual device along with the cumulative balance of the screen time accumulation bank to the individual user and the administrative user.

In some embodiments, the execution module may be configured to cross-check the current time with the schedule rules set up in the configuration module before permitting individual user engagement with the client device. For instance, if the schedule rules prohibit screen time during school hours, the execution algorithm may prevent the individual user from accessing their device during these hours. This operational variation ensures that the screen time rules set up by the administrative user are adhered to, promoting responsible screen time usage.

In other embodiments, the administrative user may have the ability to manually override the screen time limits set by the behavior rules setup step. For example, the administrative user may allow additional screen time for the individual user beyond the balance in the screen time accumulation bank, or restrict screen time even when the balance is positive. This operational variation provides the administrative user with flexibility and control over the individual user's screen time, allowing for adjustments based on specific circumstances or changes in the individual user's behavior.

In some embodiments, the behavior rules setup step of the configuration module may generate a manual input rule based on tasks designated by the user. For instance, the user may set a rule that grants additional screen time upon completion of specific tasks such as homework, chores, or physical activities. The task verification algorithm, which is part of the activity tracking module, may then generate a screen time allotment grant upon verification of task completion. This operational variation may provide a way for users to earn additional screen time by completing designated tasks, thereby promoting a balance between screen time and other activities.

In some embodiments, the manual input rule may include a task deadline. The task verification algorithm may condition the screen time allotment grant based on satisfaction of the manual input rule on or before the task deadline. For example, if a user sets a rule that grants additional screen time upon completion of a homework assignment by 5 PM, the task verification algorithm may generate a screen time allotment grant if the user verifies completion of the homework assignment before the 5 PM deadline. If the task is not completed by the deadline, the screen time allotment grant may not be generated. This operational variation may encourage timely completion of tasks and responsible management of time.

In other embodiments, the execution module of the system may include a display function. This function may present the balance of the screen time accumulation bank to the individual user and the administrative user. For example, the display function may show the current balance of screen time that the individual user has earned through physical activities or task completion. This functional variation may provide users with a clear and real-time understanding of their screen time balance, thereby enabling them to manage their screen time more effectively. The display function may be presented on a user interface of the client device, providing real-time information about the available screen time. This feature may enable the individual user to manage their screen time effectively and the administrative user to monitor the individual user's screen time usage.

In some embodiments, the behavior rules setup step of the configuration module may generate an automatic input rule based on physical activity targets designated by the user. For instance, the user may set a rule that grants additional screen time upon achieving a specific number of steps or minutes of physical activity. The reference algorithm, which is part of the activity tracking module, may then generate a screen time allotment grant upon meeting or exceeding these physical activity targets. This operational variation may provide a way for users to earn additional screen time by engaging in physical activities, thereby promoting a balance between screen time and physical activity.

In some embodiments, the automatic input rule may include a physical activity target of a predetermined number of steps. The reference algorithm may generate the screen time allotment grant upon the user exceeding the predetermined number of steps. For example, if a user sets a rule that grants additional screen time upon achieving 10,000 steps in a day, the reference algorithm may generate a screen time allotment grant if the user's step count exceeds 10,000 steps. This operational variation may encourage physical activity and provide a tangible reward for achieving fitness goals.

In other embodiments, the administrative user may have the ability to manually override the screen time limits set by the behavior rules setup step. For example, the administrative user may allow additional screen time for the individual user beyond the balance in the screen time accumulation bank, or restrict screen time even when the balance is positive. This operational variation provides the administrative user with flexibility and control over the individual user's screen time, allowing for adjustments based on specific circumstances or changes in the individual user's behavior. For instance, the administrative user may choose to grant additional screen time as a reward for exceptional behavior or achievement, or restrict screen time as a consequence for not adhering to rules or expectations.

In some embodiments, the execution module of the system may include a display function. This function may present the balance of the screen time accumulation bank to the individual user and the administrative user. The balance of the screen time accumulation bank represents the total amount of screen time available to the individual user, which may be earned through the completion of tasks or achievement of physical activity targets as defined by the behavior rules setup step of the configuration module.

The display function may provide a visual representation of the screen time balance on a user interface of the client device. This real-time information about the available screen time may enable the individual user to manage their screen time effectively. For instance, the individual user may choose to save their screen time for later use or spend it immediately based on the displayed balance.

In addition to the individual user, the administrative user may also view the balance of the screen time accumulation bank. This feature may enable the administrative user to monitor the individual user's screen time usage and the effectiveness of the behavior rules in promoting a balance between screen time and other activities.

In some embodiments, the behavior rules setup step of the configuration module may generate a manual input rule based on tasks designated by the user. For instance, the user may set a rule that grants additional screen time upon completion of specific tasks such as homework, chores, or physical activities. The task verification algorithm, which is part of the activity tracking module, may then generate a screen time allotment grant upon verification of task completion. This functional variation may provide a way for users to earn additional screen time by completing designated tasks, thereby promoting a balance between screen time and other activities.

The manual input rule may be customized according to the user's preferences and requirements. For example, the user may set a rule that grants more screen time for completing more challenging tasks or less screen time for easier tasks. The user may also set a rule that grants screen time based on the quality of task completion, such as the accuracy of homework answers or the thoroughness of chores.

In some embodiments, the execution module may further include a display function for presenting the balance of the screen time accumulation bank to the individual user and the administrative user. This function may provide a visual representation of the screen time balance on a user interface of the client device. The display function may update in real-time as the individual user earns or spends screen time, providing up-to-date information about the available screen time. This feature may enable the individual user to manage their screen time effectively and the administrative user to monitor the individual user's screen time usage.

In some embodiments, the administrative user may have the ability to manually override the screen time limits set by the behavior rules setup step. For instance, the administrative user may allow additional screen time for the individual user beyond the balance in the screen time accumulation bank, or restrict screen time even when the balance is positive. This operational variation provides the administrative user with flexibility and control over the individual user's screen time, allowing for adjustments based on specific circumstances or changes in the individual user's behavior. For example, the administrative user may choose to grant additional screen time as a reward for exceptional behavior or achievement, or restrict screen time as a consequence for not adhering to rules or expectations.

In some embodiments, the behavior rules setup step may generate an automatic input rule based on physical activity targets designated by the user. For instance, the user may set a rule that grants additional screen time upon achieving a specific number of steps or minutes of physical activity. The reference algorithm, which is part of the activity tracking module, may then generate a screen time allotment grant upon meeting or exceeding these physical activity targets. This functional variation may provide a way for users to earn additional screen time by engaging in physical activities, thereby promoting a balance between screen time and physical activity.

In other embodiments, the system may include an application programming interface (API) that allows a data source to access data or allows a third-party data source to send data. This configuration variation may facilitate the integration of the system with other applications or devices, enhancing its functionality and usability. For example, the API may allow a fitness tracking application to send physical activity data to the system, which can then be used to adjust the individual user's screen time based on the automatic input rule. Similarly, the API may allow a task management application to send task completion data to the system, which can then be used to adjust the individual user's screen time based on the manual input rule. This feature may enable the system to dynamically adjust screen time limits based on a wide range of behavioral data, providing a comprehensive and flexible approach to managing screen time.

In some embodiments, the system includes an API that allows a data source to access data or allows a third-party data source to send data by matching the sanctioned user list with the device ID or IP address of that data source. This feature allows for better accountability and verification of the enable the system to dynamically adjust screen time limits based on a wide range of behavioral data and provide screen time access across a wide range of devices. For example, the physical activity data may be generated by the accelerometer application of a smartphone device of the individual which may be used to dynamically adjust cumulative screen time limit for the user across other devices such as laptop and tablet.

In other embodiments, the system may include an adapter which enables connection of a wider variety of devices to an individual user account, namely a television or video game system. This configuration variation may expand the range of devices that can be managed by the system, thereby enhancing its applicability and effectiveness. For instance, the adapter may allow the system to monitor and control screen time on a television or video game system, in addition to the individual user's personal devices such as a smartphone or tablet. This feature may provide a more comprehensive solution for managing screen time, as it covers a broader range of digital devices that the individual user may interact with.

In some embodiments, the system may include an adapter that enables the connection of a wider variety of devices to an individual user account, such as a television or video game system. This operational variation may expand the range of devices that can be managed by the system, thereby enhancing its applicability and effectiveness. For instance, the adapter may allow the system to monitor and control screen time on a television or video game system, in addition to the individual user's personal devices such as a smartphone or tablet. This feature may provide a more comprehensive solution for managing screen time, as it covers a broader range of digital devices that the individual user may interact with.

In other embodiments, the administrative user may configure the process to allow for the individual user to select their reward for compliance with one or more automatic input rules and/or one or more manual input rules. This operational variation provides the administrative user with the flexibility to incentivize the individual user's behavior in a manner that is tailored to the individual user's preferences or motivations. For example, the administrative user may set up a rule that grants the individual user a reward, such as additional screen time, a special privilege, or a tangible reward, upon completion of a specific task or achievement of a physical activity target. This feature may enhance the effectiveness of the system in promoting a balance between screen time and other activities, as it provides a tangible incentive for the individual user to engage in non-digital activities.

In some embodiments, the administrative user may have the ability to configure the process to allow for the individual user to select their reward for compliance with one or more automatic input rules and/or one or more manual input rules. This operational variation provides the administrative user with the flexibility to incentivize the individual user's behavior in a manner that is tailored to the individual user's preferences or motivations. For example, the administrative user may set up a rule that grants the individual user a reward, such as additional screen time, a special privilege, or a tangible reward, upon completion of a specific task or achievement of a physical activity target. This feature may enhance the effectiveness of the system in promoting a balance between screen time and other activities, as it provides a tangible incentive for the individual user to engage in non-digital activities.

In some embodiments, the behavior rules setup step of the configuration module may be configured to recommend a variety of rules including automatic input rules or manual input rules. These rules may be based on third-party health or lifestyle coaching applications. This configuration variation may provide the administrative user with a range of pre-set rules that are based on established health or lifestyle guidelines, thereby simplifying the process of setting up behavior rules. For instance, the behavior rules setup step may recommend an automatic input rule that grants additional screen time based on the individual user's step count, as recommended by a third-party fitness coaching application. Similarly, the behavior rules setup step may recommend a manual input rule that grants additional screen time upon completion of a mindfulness exercise, as recommended by a third-party mental health coaching application. This feature may enhance the user-friendliness of the system and provide the administrative user with guidance in setting up effective and beneficial behavior rules.

In some embodiments, the behavior rules setup step of the configuration module may be configured to recommend a variety of rules, including automatic input rules or manual input rules. These rules may be based on third-party health or lifestyle coaching applications. This configuration variation may provide the administrative user with a range of pre-set rules that are based on established health or lifestyle guidelines, thereby simplifying the process of setting up behavior rules. For instance, the behavior rules setup step may recommend an automatic input rule that grants additional screen time based on the individual user's step count, as recommended by a third-party fitness coaching application. Similarly, the behavior rules setup step may recommend a manual input rule that grants additional screen time upon completion of a mindfulness exercise, as recommended by a third-party mental health coaching application. This feature may enhance the user-friendliness of the system and provide the administrative user with guidance in setting up effective and beneficial behavior rules.

In other embodiments, to facilitate the transfer of money, virtual currency, or other incentives, the administrative user may connect their account to a third-party financial application. This configuration variation may allow the administrative user to provide tangible rewards to the individual user for compliance with the behavior rules. For example, the administrative user may set up a rule that grants the individual user a monetary reward, such as additional allowance, upon completion of a specific task or achievement of a physical activity target. This feature may provide a tangible incentive for the individual user to engage in non-digital activities, thereby promoting a balance between screen time and other activities.

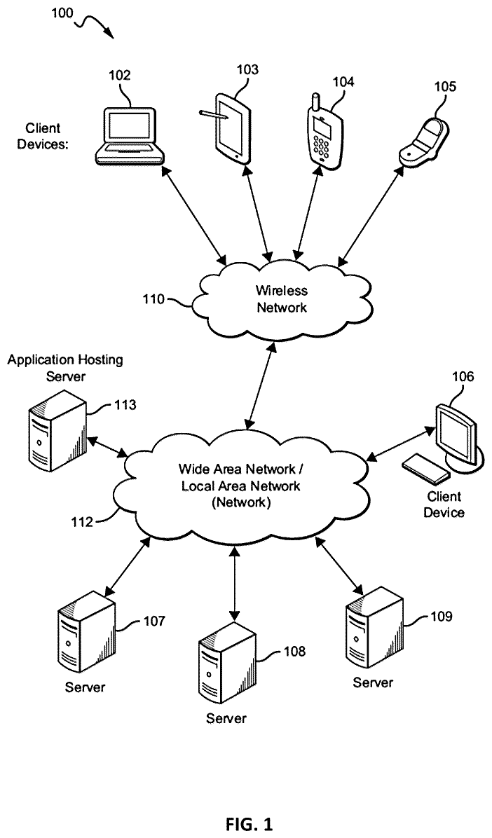

FIG. 1 illustrates components of one embodiment of an environment in which aspects of the present disclosure may be practiced. Not all of the components may be required to practice the invention, and variations in the arrangement and type of the components may be made without departing from the spirit or scope of the invention. As shown, the system 100 includes one or more Local Area Networks (“LANs”)/Wide Area Networks (“WANs”) 112, one or more wireless networks 110, one or more wired or wireless client devices 106, mobile or other wireless client devices 102-105, servers 107-109, and may include or communicate with one or more data stores or databases. Various client devices 102-106 may include, for example, desktop computers, laptop computers, set top boxes, tablets, cell phones, smart phones, smart speakers, wearable devices (such as the Apple Watch) and the like. Servers 107-109 can include, for example, one or more application servers, content servers, search servers, and the like. FIG. 1 also illustrates application hosting server 113.

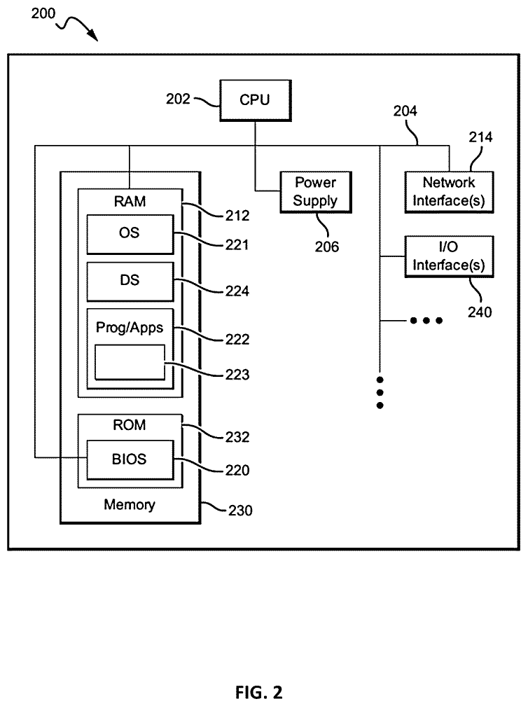

FIG. 2 illustrates a block diagram of an electronic device 200 that can implement one or more aspects of an apparatus, system and/or method for of the present disclosure (the “Engine”). Instances of the electronic device 200 may include servers, e.g., servers 107-109, and client devices, e.g., client devices 102-106. In general, the electronic device 200 can include a processor/CPU 202, memory 230, a power supply 206, and input/output (I/O) components/devices 240, e.g., microphones, speakers, displays, touchscreens, keyboards, mice, keypads, microscopes, GPS components, cameras, heart rate sensors, light sensors, accelerometers, targeted biometric sensors, etc., which may be operable, for example, to provide graphical user interfaces or text user interfaces.

A user may provide input via a touchscreen of an electronic device 200. A touchscreen may determine whether a user is providing input by, for example, determining whether the user is touching the touchscreen with a part of the user's body such as his or her fingers. The electronic device 200 can also include a communications bus 204 that connects the aforementioned elements of the electronic device 200. Network interfaces 214 can include a receiver and a transmitter (or transceiver), and one or more antennas for wireless communications.

The processor 202 can include one or more of any type of processing device, e.g., a Central Processing Unit (CPU), and a Graphics Processing Unit (GPU). Also, for example, the processor can be central processing logic, or other logic, may include hardware, firmware, software, or combinations thereof, to perform one or more functions or actions, or to cause one or more functions or actions from one or more other components. Also, based on a desired application or need, central processing logic, or other logic, may include, for example, a software-controlled microprocessor, discrete logic, e.g., an Application Specific Integrated Circuit (ASIC), a programmable/programmed logic device, memory device containing instructions, etc., or combinatorial logic embodied in hardware. Furthermore, logic may also be fully embodied as software.

The memory 230, which can include Random Access Memory (RAM) 212 and Read Only Memory (ROM) 232, can be enabled by one or more of any type of memory device, e.g., a primary (directly accessible by the CPU) or secondary (indirectly accessible by the CPU) storage device (e.g., flash memory, magnetic disk, optical disk, and the like). The RAM can include an operating system 221, data storage 224, which may include one or more databases, and programs and/or applications 222, which can include, for example, software aspects of the program 223. The ROM 232 can also include Basic Input/Output System (BIOS) 220 of the electronic device.

Software aspects of the program 223 are intended to broadly include or represent all programming, applications, algorithms, models, software and other tools necessary to implement or facilitate methods and systems according to embodiments of the invention. The elements may exist on a single computer or be distributed among multiple computers, servers, devices or entities.

The power supply 206 contains one or more power components and facilitates supply and management of power to the electronic device 200.

The input/output components, including Input/Output (I/O) interfaces 240, can include, for example, any interfaces for facilitating communication between any components of the electronic device 200, components of external devices (e.g., components of other devices of the network or system 100), and end users. For example, such components can include a network card that may be an integration of a receiver, a transmitter, a transceiver, and one or more input/output interfaces. A network card, for example, can facilitate wired or wireless communication with other devices of a network. In cases of wireless communication, an antenna can facilitate such communication. Also, some of the input/output interfaces 240 and the bus 204 can facilitate communication between components of the electronic device 200, and in an example can ease processing performed by the processor 202.

Where the electronic device 200 is a server, it can include a computing device that can be capable of sending or receiving signals, e.g., via a wired or wireless network, or may be capable of processing or storing signals, e.g., in memory as physical memory states. The server may be an application server that includes a configuration to provide one or more applications, e.g., aspects of the Engine, via a network to another device. Also, an application server may, for example, host a web site that can provide a user interface for administration of example aspects of the Engine.

Any computing device capable of sending, receiving, and processing data over a wired and/or a wireless network may act as a server, such as in facilitating aspects of implementations of the Engine. Thus, devices acting as a server may include devices such as dedicated rack-mounted servers, desktop computers, laptop computers, set top boxes, integrated devices combining one or more of the preceding devices, and the like.

Servers may vary widely in configuration and capabilities, but they generally include one or more central processing units, memory, mass data storage, a power supply, wired or wireless network interfaces, input/output interfaces, and an operating system such as Windows Server, Mac OS X, Unix, Linux, FreeBSD, and the like.

A server may include, for example, a device that is configured, or includes a configuration, to provide data or content via one or more networks to another device, such as in facilitating aspects of an example apparatus, system and method of the Engine. One or more servers may, for example, be used in hosting a Web site, such as the web site www.microsoft.com. One or more servers may host a variety of sites, such as, for example, business sites, informational sites, social networking sites, educational sites, wikis, financial sites, government sites, personal sites, and the like.

Servers may also, for example, provide a variety of services, such as Web services, third-party services, audio services, video services, email services, HTTP or HTTPS services, Instant Messaging (IM) services, Short Message Service (SMS) services, Multimedia Messaging Service (MMS) services, File Transfer Protocol (FTP) services, Voice Over IP (VOIP) services, calendaring services, phone services, and the like, all of which may work in conjunction with example aspects of an example systems and methods for the apparatus, system and method embodying the Engine. Content may include, for example, text, images, audio, video, and the like.

In example aspects of the apparatus, system and method embodying the Engine, client devices may include, for example, any computing device capable of sending and receiving data over a wired and/or a wireless network. Such client devices may include desktop computers as well as portable devices such as cellular telephones, smart phones, display pagers, Radio Frequency (RF) devices, Infrared (IR) devices, Personal Digital Assistants (PDAs), handheld computers, GPS-enabled devices tablet computers, sensor-equipped devices, laptop computers, set top boxes, wearable computers such as the Apple Watch and Fitbit, integrated devices combining one or more of the preceding devices, and the like.

Client devices such as client devices 102-106, as may be used in an example apparatus, system and method embodying the Engine, may range widely in terms of capabilities and features. For example, a cell phone, smart phone or tablet may have a numeric keypad and a few lines of monochrome Liquid-Crystal Display (LCD) display on which only text may be displayed. In another example, a Web-enabled client device may have a physical or virtual keyboard, data storage (such as flash memory or SD cards), accelerometers, gyroscopes, respiration sensors, body movement sensors, proximity sensors, motion sensors, ambient light sensors, moisture sensors, temperature sensors, compass, barometer, fingerprint sensor, face identification sensor using the camera, pulse sensors, heart rate variability (HRV) sensors, beats per minute (BPM) heart rate sensors, microphones (sound sensors), speakers, GPS or other location-aware capability, and a 2D or 3D touch-sensitive color screen on which both text and graphics may be displayed. In some embodiments multiple client devices may be used to collect a combination of data. For example, a smart phone may be used to collect movement data via an accelerometer and/or gyroscope and a smart watch (such as the Apple Watch) may be used to collect heart rate or other activity data. The multiple client devices (such as a smart phone and a smart watch) may be communicatively coupled.

Client devices, such as client devices 102-106, for example, as may be used in an example apparatus, system and method implementing the Engine, may run a variety of operating systems, including personal computer operating systems such as Windows, iOS or Linux, and mobile operating systems such as iOS, Android, Windows Mobile, and the like. Client devices may be used to run one or more applications that are configured to send or receive data from another computing device. Client applications may provide and receive textual content, multimedia information, and the like. Client applications may perform actions such as browsing webpages, using a web search engine, interacting with various apps stored on a smart phone, sending and receiving messages via email, SMS, or MMS, playing games (such as fantasy sports leagues), receiving advertising, watching locally stored or streamed video, or participating in social networks.

In example aspects of the apparatus, system and method implementing the Engine, one or more networks, such as networks 110 or 112, for example, may couple servers and client devices with other computing devices, including through wireless network to client devices. A network may be enabled to employ any form of computer readable media for communicating information from one electronic device to another. The computer readable media may be non-transitory. A network may include the Internet in addition to Local Area Networks (LANs), Wide Area Networks (WANs), direct connections, such as through a Universal Serial Bus (USB) port, other forms of computer-readable media (computer-readable memories), or any combination thereof. On an interconnected set of LANs, including those based on differing architectures and protocols, a router acts as a link between LANs, enabling data to be sent from one to another.

Communication links within LANs may include twisted wire pair or coaxial cable, while communication links between networks may utilize analog telephone lines, cable lines, optical lines, full or fractional dedicated digital lines including T1, T2, T3, and T4, Integrated Services Digital Networks (ISDNs), Digital Subscriber Lines (DSLs), wireless links including satellite links, optic fiber links, or other communications links known to those skilled in the art. Furthermore, remote computers and other related electronic devices could be remotely connected to either LANs or WANs via a modem and a telephone link.

A wireless network, such as wireless network 110, as in an example apparatus, system and method implementing the Engine, may couple devices with a network. A wireless network may employ stand-alone ad-hoc networks, mesh networks, Wireless LAN (WLAN) networks, cellular networks, and the like.

A wireless network may further include an autonomous system of terminals, gateways, routers, or the like connected by wireless radio links, or the like. These connectors may be configured to move freely and randomly and organize themselves arbitrarily, such that the topology of wireless network may change rapidly. A wireless network may further employ a plurality of access technologies including 2nd (2G), 3rd (3G), 4th (4G) generation, Long Term Evolution (LTE) radio access for cellular systems, WLAN, Wireless Router (WR) mesh, and the like. Access technologies such as 2G, 2.5G, 3G, 4G, and future access networks may enable wide area coverage for client devices, such as client devices with various degrees of mobility. For example, a wireless network may enable a radio connection through a radio network access technology such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, and the like. A wireless network may include virtually any wireless communication mechanism by which information may travel between client devices and another computing device, network, and the like.

Internet Protocol (IP) may be used for transmitting data communication packets over a network of participating digital communication networks, and may include protocols such as TCP/IP, UDP, DECnet, NetBEUI, IPX, Appletalk, and the like. Versions of the Internet Protocol include IPv4 and IPv6. The Internet includes local area networks (LANs), Wide Area Networks (WANs), wireless networks, and long-haul public networks that may allow packets to be communicated between the local area networks. The packets may be transmitted between nodes in the network to sites, each of which has a unique local network address. A data communication packet may be sent through the Internet from a user site via an access node connected to the Internet. The packet may be forwarded through the network nodes to any target site connected to the network provided that the site address of the target site is included in a header of the packet. Each packet communicated over the Internet may be routed via a path determined by gateways and servers that switch the packet according to the target address and the availability of a network path to connect to the target site.

The header of the packet may include, for example, the source port (16 bits), destination port (16 bits), sequence number (32 bits), acknowledgement number (32 bits), data offset (4 bits), reserved (6 bits), checksum (16 bits), urgent pointer (16 bits), options (variable number of bits in multiple of 8 bits in length), padding (may be composed of all zeros and includes a number of bits such that the header ends on a 32 bit boundary). The number of bits for each of the above may also be higher or lower.

A “content delivery network” or “content distribution network” (CDN), as may be used in an example apparatus, system and method implementing the Engine, generally refers to a distributed computer system that comprises a collection of autonomous computers linked by a network or networks, together with the software, systems, protocols and techniques designed to facilitate various services, such as the storage, caching, or transmission of content, streaming media and applications on behalf of content providers. Such services may make use of ancillary technologies including, but not limited to, “cloud computing,” distributed storage, DNS request handling, provisioning, data monitoring and reporting, content targeting, personalization, and business intelligence. A CDN may also enable an entity to operate and/or manage a third party's web site infrastructure, in whole or in part, on the third party's behalf.

A Peer-to-Peer (or P2P) computer network relies primarily on the computing power and bandwidth of the participants in the network rather than concentrating it in a given set of dedicated servers. P2P networks are typically used for connecting nodes via largely ad hoc connections. A pure peer-to-peer network does not have a notion of clients or servers, but only equal peer nodes that simultaneously function as both “clients” and “servers” to the other nodes on the network.

Embodiments of the present invention include apparatuses, systems, and methods implementing the Engine. Embodiments of the present invention may be implemented on one or more of client devices 102-106, which are communicatively coupled to servers including servers 107-109. Moreover, client devices 102-106 may be communicatively (wirelessly or wired) coupled to one another. In particular, software aspects of the Engine may be implemented in the program 223. The program 223 may be implemented on one or more client devices 102-106, one or more servers 107-109, and 113, or a combination of one or more client devices 102-106, and one or more servers 107-109 and 113.

In some embodiments, the apparatus, system and method embodying the Engine may record the device ID or the IP address of the Client devices such as client devices 102-106, as may be used in an example. In some embodiments, the apparatus, system and method embodying the Engine may match the device ID or the IP address of the Client devices such as client devices 102-106 against a sanctioned user list comprising device ID or device IP addresses of the Client devices to allow or deny specific features or functions of the apparatus, system and method embodying the Engine recited in various embodiments of this disclosure.

In an embodiment, the system may receive, process, generate and/or store time series data. The system may include an application programming interface (API). The API may include an API subsystem. The API subsystem may allow a data source to access data. The API subsystem may allow a third-party data source to send the data. In one example, the third-party data source may send JavaScript Object Notation (“JSON”)-encoded object data. In an embodiment, the object data may be encoded as XML-encoded object data, query parameter encoded object data, or byte-encoded object data.

The present disclosure may relate to a computer-implemented system for managing screen usage based on activity inputs. The platform may be effective for users who struggle to limit their screen time, wish to incentivize healthy habits, or otherwise wish to improve their digital health practices. The platform may be useful for individuals or families, particularly those seeking to provide incentives for children to complete analog tasks such as household chores, homework, reading, meditation, or other activities.

The platform may provide a method for managing screen time on an individual basis via an algorithm that compiles activity data from multiple inputs and grants users screen time based on their completion of predetermined activities.

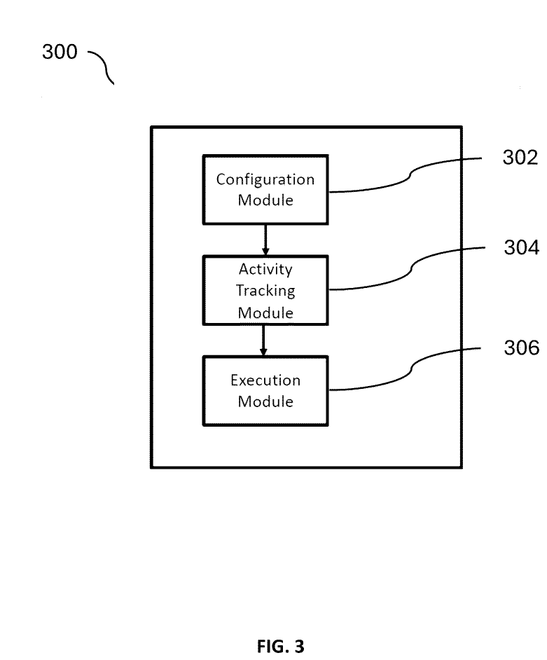

FIG. 3 illustrates a high-level process flow for limiting screen time based on activity data. Specifically, FIG. 3 is an illustrative block diagram of process 300 for monitoring activity data and allotting screen time based on the activity data. A non-exhaustive list of types of activity data includes a user's step count, distance travelled, calories burned, active minutes, completed tasks, meditation time, and/or reading time, and so on. Process 300 may include a configuration module 302, an activity tracking module 304 and an execution module 306. In a distributed computing environment, these modules may be located in both local and remote storage devices including memory storage devices. Each module may be executed as a result of execution instructions received via client device 102-106. The details and variations of the configuration module 302, the activity module 304 and the execution module 306 have been described in previous sections.

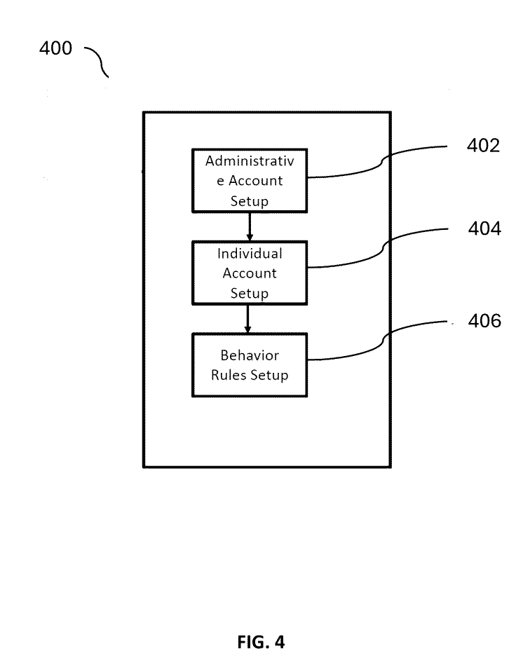

FIG. 4 shows a configuration module workflow process 400. An administrative user may initiate use of process 400 via one or more client devices 102-105. The first step of process 400 may include administrative account setup 402. Administrative account setup 402 may comprise configuration of a required administrative user account 408 and the associated security measures to access the administrative user account 408. In an embodiment, access to the administrative user account 408 may be secured by a personal identification number, biometric input (i.e., fingerprint or facial recognition, which may be determined according to the capabilities of client device 102-105), dual-factor authentication, or another desired security method.

The configuration module 400 may allow the administrative user to configure one or more individual accounts 410 via individual account setup 404. Individual account setup 404 may require identification of one or more individual users for process 400. Individual account setup 404 may require, the administrative user to indicate demographic information such as age, sex, health data, goals, and/or current digital health habits for each individual user. For example, a parent may configure their own account as the administrative user account via the administrative account setup 408 and may subsequently configure an individual account 410 for each of their children via individual account setup 404. In an embodiment, the administrative user may have the option to designate themselves as an individual user. In an embodiment, the individual account setup 404 may require the administrative user to designate input sources for individual user's activity data.

In some embodiments, the individual account setup 404 may require the administrative user to designate one or more user devices 102-106 from which activity data may be collected. As a non-limiting example, the administrative user may designate that a fitness tracker may share health data such as steps taken, minutes of activity, or other measured data with the process 300. Connectivity to multiple input sources of activity data may enable the process 300 to cross-check activity data with other sources, lowering the likelihood of inaccurate activity data and allowing for input of multiple types of activity data, including but not limited to task completion, physical activity, reading or homework applications, and meditation applications.

In an embodiment, the individual account setup 404 may require that the individual user account be linked to one or more user devices 102-106 for the purpose of limiting the individual user's time using the one or more user devices 102-106. As a non-limiting example, an individual user account may be configured to limit the time spent engaging with a phone, a tablet, and/or a laptop, each connected to an individual user account. In some embodiments, the system 300 may comprise an adapter which enables connection of a wider variety of devices to an individual user account, namely a television or video game system.

In some embodiments, multiple-device connectivity to a single user account may enable the administrative user to more effectively limit the total screen time of the individual user. In some embodiments, the administrative user may be a parent and the individual user may be a child. It is also contemplated that the administrative user may be an adult and the individual user may be the same person, as many adults struggle to set effective digital boundaries. It is further contemplated that the administrative user may be a child and the individual user may be a child. For the sake of clarity, examples using “parent” and “child” refer to the administrative user as the parent and the individual user as the child.

The configuration module may comprise a behavior rules setup 406. In an embodiment, the behavior rules setup 406 may require the administrative user to designate a screen time allowance to be disbursed upon collected from the one or more user devices 102-106. In an embodiment, the behavior rules setup 406 may prompt the administrative user to designate one or more automatic input rules 412. An automatic input rule 412 may require that the individual user configure a device to monitor their behavior, such as a fitness tracker, geo-location device, or automatically tracking application. As a non-limiting example, a parent administrative user may designate an automatic input rule 412 which permits a child individual user one minute of screen time for every one minute of physical activity collected via an input device such as a fitness tracker. An administrative user may rely on predetermined physical activity parameters set by fitness trackers or other programs or may adjust the physical activity parameters as desired. As a non-limiting example, the administrative user seeking to improve the physical health of the individual user by increasing their daily walking distance may designate an automatic input rule 412 that permits the individual user 60 minutes of screen time if their total daily step count surpasses 10,000 steps.

In an embodiment, the behavior rules setup 406 may require that the administrative user set one or more manual input rules 414. Manual input rules 414 may require a user's attention to grant screen time. In an embodiment, the manual input rules 414 may require completion approval by both the individual user and the administrative user before screen time is granted to the individual user. In an embodiment, the manual input rules may only require completion approval by the individual user before screen time is granted to the individual user. As a non-limiting example, the administrative user seeking to improve their focus may designate that the individual user may only use their limited screen time balance after they complete of a predetermined list of tasks (i.e., work tasks, household duties, school assignments). Once the individual user has completed a task, they may indicate, via a user device, that the task is complete. If, in an embodiment, the manual input rule 414 is configured to require only individual user completion approval, the predetermined amount of screen time associated with the task may be disbursed to the individual user. If, for example, the manual input rule 414 is configured to require both individual user completion approval and administrative user completion approval, the individual user may first be required to submit completion approval before a final approval prompt is presented to the administrative user via one or more user devices 102-106. The requirement of administrative user approval may be particularly useful to parents who wish to exercise additional oversight of their children's digital habits.

In an embodiment, the administrative user may configure for the individual user a set of schedule rules 416. The schedule rules 416 may dictate the times of day or night during which screen time is wholly prohibited. Scheduling screen time-free hours may promote better focus for the individual user, for example during work, school, or sleeping hours. In an embodiment, the schedule rules 416 permit use of certain applications during restricted screen-time hours. As a non-limiting example, a school-age child may be permitted to use their electronic devices for educational purposes during school hours. As a non-limiting example, a parent disciplining their child for misbehavior may adjust schedule rule(s) 416 to allow for little to no screen time for a predetermined period of time. As a non-limiting example, a parent seeking to enforce a digital bedtime on weeknights may adjust the schedule rule(s) 416 to restrict screen time past a predetermined hour on Sunday through Thursday evenings.

In an embodiment, behavior rules setup 406 may prompt the administrative user to configure for the individual user a limit on the amount of screen time that may be accumulated during a certain period. As a non-limiting example, a user may be limited to 4 hours of screen time per day, regardless of the behavior inputs received by the process 300.

In an embodiment, the behavior rules setup 406 may be configured to recommend a variety of rules including automatic input rules 412 or manual input rules 414. These rules may be based on third-party health or lifestyle coaching applications. As a non-limiting example, the administrative user who has, through a third-party application, set a goal to meditate once per day, may be prompted to incentivize their meditation goal by limiting screen time until its completion.

In some embodiments the configuration module 400 includes a sanctioned user database 416 comprising a list of allowable IP addresses residing in the program instructions stored on the computer-readable storage device allowing or denying the at least one client device to communicate with an activation module residing in the program instructions stored on said computer-readable storage device based on the at least one client device IP address matching a stored at least one IP address stored in the computer-readable storage device sanctioned user list of allowable IP addresses and if the activation module allows access then;

In some embodiments the sanctioned user database 416 includes a list of allowable device IDs residing in the program instructions stored on the computer-readable storage device allowing or denying the at least one client device to communicate with an activation module residing in the program instructions stored on said computer-readable storage device based on the at least one client device ID matching a stored at least one device ID stored in the computer-readable storage device sanctioned user database of allowable device IDs and if the activation module allows access then.

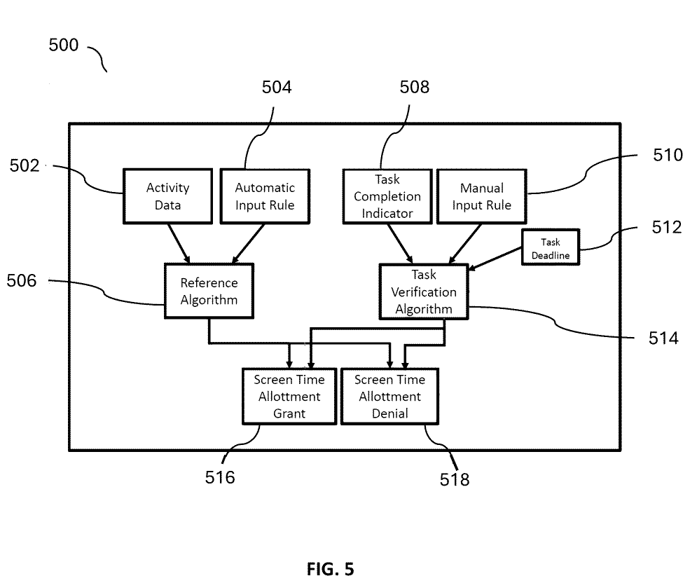

FIG. 5 shows a workflow process of the activity tracking module 500. The activity tracking module 500 may comprise an activity data module 502. The activity data module 502 may gather activity data for the individual user from any linked device, including but not limited to fitness trackers, smart watches, smart phones, and geo-location devices. The activity tracking module 500 may compile and store data in an activity database 714/814. In some embodiments, the behavior data collection module may compile geo-location data from a 24-hour period to determine if the individual user visited predetermined locations. As a non-limiting example, the activity data module 502 may compile GPS data for the individual user who designated a rule in behavior rules setup 406 that required they visit a library to earn screen time.

The activity tracking module 500 may further comprise a reference algorithm 506 which creates a feedback loop by comparing behavior data to the automatic input rule(s) 504 (similar to 412 designated in the behavior rules setup 406). As a non-limiting example, the reference algorithm 506 may compare a collected step count of 8,000 to an automatic input rule 504 requiring that the individual user surpass 10,000 steps per day to earn screen time and return an indicator that the individual user has failed to meet their goal and that the predetermined screen time allotment should be denied. As a non-limiting example, the reference algorithm 506 may compare heart rate data which indicates that the individual user exercised for 75 minutes on a given day to an automatic input rule 504 requiring that the individual user exercise 60 minutes or more per day and return an indicator that the individual user has met their goal and that the predetermined screen time allotment should be granted.

The activity tracking module 500 may further comprise a task verification algorithm 514. The task verification algorithm 514 may compile data relating to the status of compliance with the manual input rules 510 (similar to 414 described previously). In an embodiment, the task verification algorithm may associate a manual input rule 510 with a task deadline 512. The task deadline 512 may be a time by which the task associated with a manual input rule 510 must be marked complete. In some embodiments, the task verification algorithm 514 may condition the screen time grant 516 based on satisfaction of the manual input rule 510 on or before the task deadline 512. In an embodiment, the manual input rule 510 may be designated without a task deadline 512. In an embodiment, the task verification algorithm 514 may create a feedback loop wherein the input is the manual verification of the completion of a task designated by the manual input rule 510 and the output is an indicator of the amount of screen time to be granted.

In some embodiments, the task verification algorithm 514 may require the individual user to certify that a task has been completed by submitting a task completion indicator 508 before disbursing the allotted screen time. In an embodiment, the task verification algorithm 514 may require both the individual user and the administrative user to submit a task completion indicator 508 before disbursing the allotted screen time. The task verification algorithm 514 may be customized according to the preferences of the administrative user. As an example, as a parent develops trust with their child(ren), the requirement that the administrative user submit a task completion indicator 508 may be removed. As another non-limiting example, a parent who prefers to exercise more significant oversight may require that the administrative user submit a task completion indicator 508.

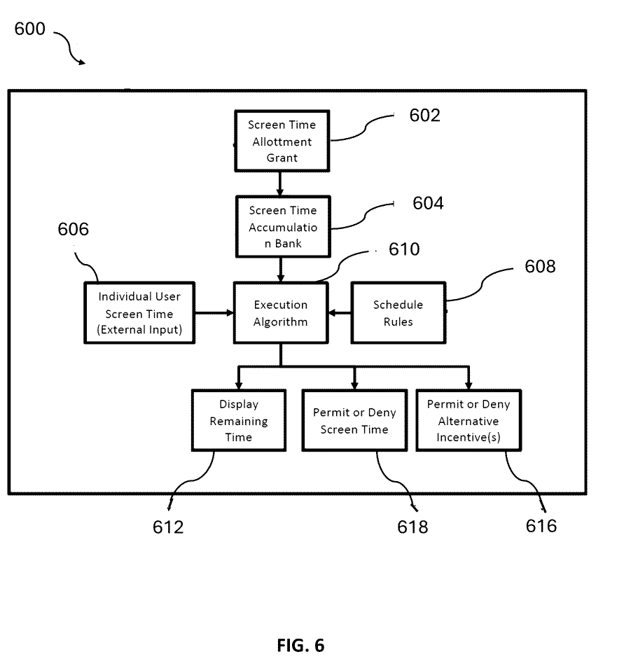

FIG. 6 shows the workflow process of the execution module 600. The execution module 600 may comprise a screen time accumulation bank 604. The screen time accumulation bank 604 may compile data from the screen time allotment grant(s) 516 and/or the screen time allotment denial(s) 518 generated by the activity tracking module 500. The execution module 600 may display the balance of the screen time accumulation bank 604 to the individual user(s) and/or to the administrative user(s). In an embodiment, the execution module may display the balance of the screen time accumulation bank 604 to the individual user(s) or to the administrative user(s) in real time.

The execution module 600 may track screen time based on individual user engagement with one or more client devices 102-106. In an embodiment, when the balance of the screen time accumulation bank 604 reaches zero, the execution module may lock the individual user's device(s) until the balance of the screen time accumulation bank 604 is increased. In an embodiment, when the balance of the screen time accumulation bank 604 reaches zero, the execution module may limit the functionality of the individual user's device(s) until the balance of the screen time accumulation bank 604 is increased.

In some embodiments, when the administrative user has set a manual input rule 510 with a task deadline 512, the execution module may prompt the individual user to complete the task associated with the manual input rule 510, and/or may restrict the screen time of the individual user until the task is marked complete. As a non-limiting example, if a parent requires verification that a child provides care for the family pet before 5:00 each day, the execution module 600 may restrict the child's screen time from the 5:00 deadline until the task is marked complete in accordance with the manual input rule 510.

In an embodiment, the administrative user may configure the process 300 to allow for the individual user to select their reward for compliance with one or more automatic input rules 412 and/or one or more manual input rules 414. As a non-limiting example, the administrative user may configure the process 300 to grant the individual user who satisfactorily completes 100% of their assigned household duties a monetary allowance, a gift card, a balance of virtual currency, and/or other incentives. In an embodiment, to facilitate the transfer of money, virtual currency, or other incentives, the administrative user may connect their account to a third-party financial application.

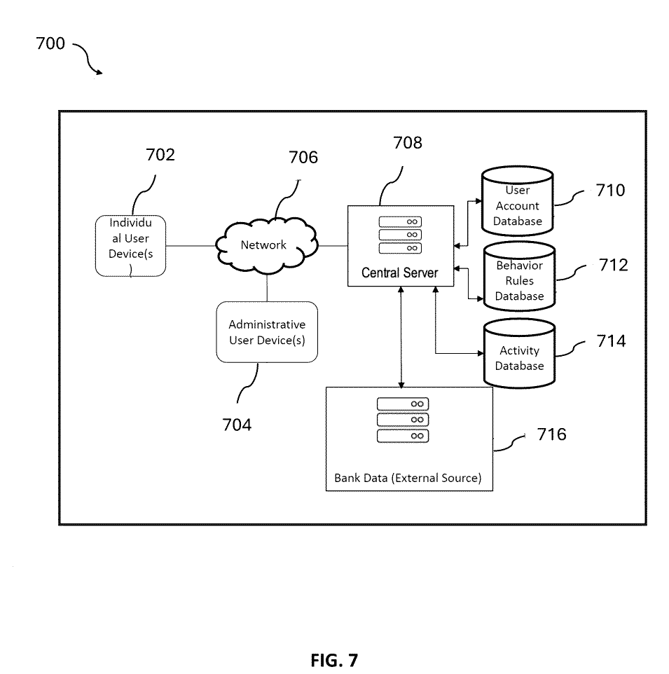

FIG. 7 shows a high-level system architecture 700 according to aspects of the present disclosure. The high-level system architecture 700 may dictate how the various information discussed herein is stored and obtained. For example, external servers 716 may store screen time bank data for use during execution module 600.

Information specific to the platform may be stored on 710/712/714. The User Account Database 710 may store user information, which may comprise which may comprise indications of user type, verified email addresses, names of user, verified phone numbers, account status, and any identifying information associated with external accounts. Such information may be received from the user via the configuration module 400. Behavior Rules Database 712 may store behavior rules data. Such behavior rules data may be data obtained during the configuration module 400, specifically the behavior rules setup 406. Activity data may be stored on activity database 714. Such activity data may be data obtained in the activity tracking module 500. Databases 710/712/714 may be stored on servers 107-109, or may exist as separate servers. In some embodiments, the interaction between the Individual user devices and the databases 710/712/714 via the network and the central server may be governed by the central server matching the device ID or the device IP address of the individual user device against a sanctioned user list leading to allowance or denial of data transfer into or out of the individual databases 710/712/714.

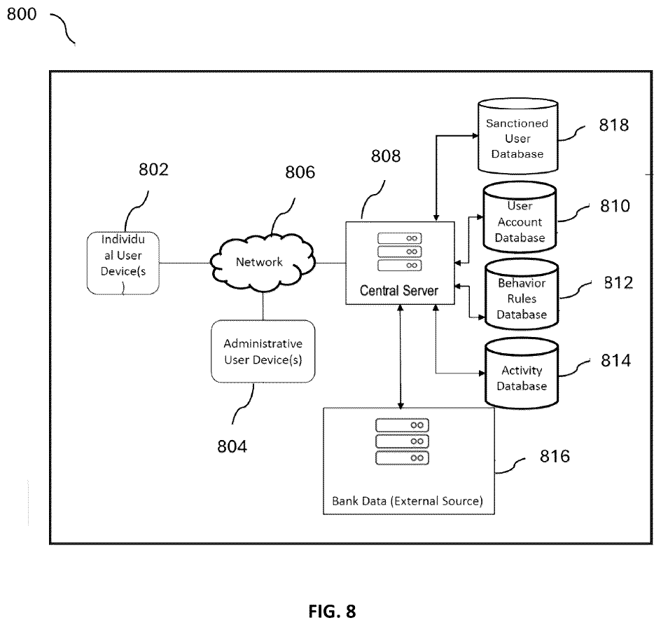

FIG. 8 shows a high-level system architecture similar to FIG. 7 further comprising a central server in communication with a sanctioned user database according to an embodiment of the present disclosure. The elements 802-816 are similar to the elements 702-716 described in previous sections. The system 800 includes a sanctioned user database 818 in communication with the central server 808, the sanctioned user database 818 comprising allowable IP addresses residing in the program instructions stored on the computer-readable storage device allowing or denying the at least one client device to communicate with an activation module residing in the program instructions stored on said computer-readable storage device based on the at least one client device IP address matching a stored at least one IP address stored in the computer-readable storage device sanctioned user database of allowable IP addresses and if the activation module allows access then.

In some embodiments, the sanctioned user database 818 includes allowable device IDs of the individual user devices residing in the program instructions stored on the computer-readable storage device allowing or denying the at least one client device to communicate with an activation module residing in the program instructions stored on said computer-readable storage device based on the at least one client device ID matching a stored at least one device ID stored in the computer-readable storage device sanctioned user list of allowable IP addresses and if the activation module allows access then.

The instant invention having a configuration module and a sanctioned user list of allowable IP addresses residing in said program instructions stored on said computer-readable storage device allowing or denying said at least one client device to communicate with an activation module residing in said program instructions stored on said computer-readable storage device based on said at least one client device IP address matching a stored at least one IP address, stored in said computer-readable storage device sanctioned user list of allowable IP addresses and if said activation module allows access then;
a. The configuration module for receiving data from a user via a client device a generates a record of the input on at least one database;
b. an activity tracking module for receiving instructions from the user via the client device and including a reference algorithm and a task verification algorithm; and
c. an execution module for receiving instructions from the user via the client device and including a screen time accumulation bank and an execution algorithm.

A number of implementations have been described. Nevertheless, it will be understood that various modifications may be made without departing from the spirit and scope of the disclosure. Accordingly, other implementations are within the scope of the following claims.

It will be apparent to those of ordinary skill in the art that methods involved in the present disclosure may be embodied in a computer program product that includes a computer usable and/or readable medium. For example, such a computer usable medium may consist of a read only memory device, such as a CD ROM disk or conventional ROM devices, or a random-access memory, such as a hard drive device or a computer diskette, or flash memory device having a computer readable program code stored thereon.

Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above-described methods, processes and/or tasks.

When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions.

The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption.

The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above-described information, or requesting that the user input updates or modifies existing stored information for processing.

A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A computer-implemented system comprising an at least one client device, a processor, a computer-readable memory, a computer-readable storage device, at least one network interface, at least one input interface, at least one output interface, and program instructions stored on the computer-readable storage device for execution by the processor via the computer-readable memory, the stored program instructions comprising:
a configuration module and a sanctioned user list of allowable IP addresses residing in said program instructions stored on said computer-readable storage device allowing or denying said at least one client device to communicate with an activation module residing in said program instructions stored on said computer-readable storage device based on said at least one client device IP address matching a stored at least one IP address, stored in said computer-readable storage device sanctioned user list of allowable IP addresses and if said activation module allows access then;
said configuration module for receiving data from a user via a client device and generating a record of the input on at least one database;
an activity tracking module for receiving instructions from the user via the client device and including a reference algorithm and a task verification algorithm; and
an execution module for receiving instructions from the user via the client device and including a screen time accumulation bank and an execution algorithm.

2. The computer-implemented system of claim 1, wherein the configuration module further includes a schedule rules setup step for defining specific periods during which screen time is permitted or prohibited.

3. The computer-implemented system of claim 2, wherein the execution module is further configured to cross-check a current time with the schedule rules before permitting individual user engagement with the client device.

4. The computer-implemented system of claim 1, wherein a behavior rules setup step generates a manual input rule based on user-designated tasks, and the task verification algorithm generates a screen time allotment grant upon verification of task completion.

5. The computer-implemented system of claim 1, wherein a behavior rules setup step generates an automatic input rule based on user-designated physical activity targets, and the reference algorithm generates a screen time allotment grant upon meeting or exceeding the physical activity targets.

6. The computer-implemented system of claim 1, wherein the execution module further includes a display function for presenting a balance of the screen time accumulation bank to an individual user and an administrative user.

7. The computer-implemented system of claim 1, wherein an administrative user can manually override screen time limits set by a behavior rules setup step.

8. A method for regulating screen time of an individual user, the method comprising:
receiving, from a user via a client device, instructions to execute a configuration module, wherein the configuration module includes at least an administrative account setup step, an individual account setup step, and a behavior rules setup step;
receiving, from the user via the client device, instructions to execute an activity tracking module, wherein the activity tracking module includes at least a reference algorithm and a task verification algorithm;
receiving, from the user via the client device, instructions to execute an execution module, wherein the execution module includes a screen time accumulation bank and an execution algorithm.

9. The method of claim 8, wherein the behavior rules setup step generates a manual input rule based on user-designated tasks, and the task verification algorithm generates a screen time allotment grant upon verification of task completion.

10. The method of claim 8, wherein the behavior rules setup step generates an automatic input rule based on user-designated physical activity targets, and the reference algorithm generates a screen time allotment grant upon meeting or exceeding the physical activity targets.

11. The method of claim 8, wherein the execution module further includes a display function for presenting a balance of the screen time accumulation bank to the individual user and the administrative user.

12. The method of claim 8, wherein the administrative user can manually override screen time limits set by the behavior rules setup step.

13. The method of claim 9, wherein the manual input rule includes a task deadline, and the task verification algorithm conditions the screen time allotment grant based on satisfaction of the manual input rule on or before the task deadline.

14. The method of claim 10, wherein the automatic input rule includes a physical activity target of a predetermined number of steps, and the reference algorithm generates the screen time allotment grant upon the user exceeding the predetermined number of steps.

15. A non-transitory computer-readable storage medium having data stored therein representing software executable by a computer, the software including instructions to:
receive, from a user via a client device, instructions to execute a configuration module, wherein the configuration module includes at least an administrative account setup step, an individual account setup step, and a behavior rules setup step;
receive, from the user via the client device, instructions to execute an activity tracking module, wherein the activity tracking module includes at least a reference algorithm and a task verification algorithm; and
receive, from the user via the client device, instructions to execute an execution module, wherein the execution module includes a screen time accumulation bank and an execution algorithm.

16. The non-transitory computer-readable storage medium of claim 15, wherein the configuration module further includes a schedule rules setup step for defining specific periods during which screen time is permitted or prohibited.

17. The non-transitory computer-readable storage medium of claim 16, wherein the execution module is further configured to cross-check a current time with the schedule rules before permitting individual user engagement with the client device.

18. The non-transitory computer-readable storage medium of claim 15, wherein the behavior rules setup step generates a manual input rule based on user-designated tasks, and the task verification algorithm generates a screen time allotment grant upon verification of task completion.

19. The non-transitory computer-readable storage medium of claim 15, wherein the behavior rules setup step generates an automatic input rule based on user-designated physical activity targets, and the reference algorithm generates a screen time allotment grant upon meeting or exceeding the physical activity targets.

20. The non-transitory computer-readable storage medium of claim 15, wherein the execution module further includes a display function for presenting a balance of the screen time accumulation bank to the individual user and the administrative user.
